(19) United States
(12) Patent Application Publication
(10) Pub. No.: US 2003/0119525 A1
(43) Pub. Date: Jun. 26, 2003

(54) System and method for locating a mobile station in a wireless network

(75) Inventor: Purva R. Rajkotia, Plano, TX (US)

Correspondence Address: Docket Clerk, P.O. Box Drawer 800889, Dallas, TX, 75380, US

(73) Assignee: SAMSUNG ELECTRONICS Co., LTD., Suwon-city (KR)

(21) Appl. No.: 10/028,571

(22) Filed: Dec. 20, 2001

(51) Int. Cl. H04Q 7/20

(52) U.S. Cl. 455/456; 455/67.6; 455/67.1

(57) ABSTRACT

A system and method is disclosed for locating a mobile station in a wireless network. A distance unit associated with a base station determines a one way travel time of a range signal from the base station to the mobile station and multiplies the one way travel time by the speed of light to obtain the distance from the base station to the mobile station. The one way travel time is equal to one half of a quantity that is equal to a two way travel time of a range signal minus a time value of a random backoff parameter of the mobile station. The distance resolution of the system is approximately two hundred forty four meters.

### TECHNICAL FIELD OF THE INVENTION

The present invention is directed, in general, to wireless telecommunications networks and, more specifically, to a system and method for locating a wireless station within a wireless network.

### BACKGROUND OF THE INVENTION

The use of cellular telephones and wireless networks has become increasingly widespread. As the use of cellular telephones increase, it has become increasingly important for the operators of cellular telephone wireless networks to be able to determine the location of cellular telephones within a cellular telephone wireless network.

When a caller calls an emergency number such as 911 it is important to be able to tell exactly where the cellular telephone is located when the call is made. The Federal Communications Commission (FCC) has recently issued regulations that require operators of cellular telephone networks to be able to locate a cellular telephone within a wireless network. The FCC Phase II requirements call for locating a cellular telephone to within three hundred (300) meters for ninety five percent (95%) of the calls.

One prior art system and method for locating a mobile station (such as a cellular telephone) within a wireless network measures signals transmitted from a mobile station and received at three or more base stations and calculates the position of the mobile station from the time of arrival (TOA) of the signals at the base stations. Another prior art system and method measures signals transmitted from a mobile station and received at three or more base stations and calculates the position of the mobile station from the time difference of arrival (TDOA) of the signals. Another prior art system and method calculates the position of the mobile station from the angle of arrival (AOA) of a signal transmitted from a mobile station to a base station.

The prior art systems and methods generally require the use of specialized equipment. For convenience, a unit of this specialized equipment will be referred to as a “position determining entity” or “PDE”. The accuracy of the mobile station location calculated by the prior art systems and methods is dependent upon the number of PDEs deployed in the wireless network.

A direct line between two PDEs is referred to as a “baseline”. The Root Mean Square (RMS) location error is inversely proportional to the square root of the number of baselines. That is, the greater the number of baselines, the smaller the location error for locating the mobile station.

In prior art systems, the PDEs are normally located at the base stations of the wireless network and share the antennas with the base stations. If base station antennas are not available, a set of antennas must be constructed for the use of the PDEs. It is very expensive to construct a new set of antennas solely for use of PDEs.

If the number of baselines is too small, then the accuracy of the location of the mobile station will be low. In rural areas the number of baselines is small. This is because there are not many base stations because the subscriber base is small. Therefore in rural areas it will be very difficult to meet the FCC requirements for determining the location of mobile stations using any of the prior art systems and methods.

In addition, the prior art systems and methods for locating a mobile station within a wireless network require from three (3) minutes up to ten (10) minutes to locate a mobile station.

There is, therefore, a need in the art for an improved system and method for locating a mobile station within a wireless network. There is a need in the art for an improved system and method for locating a mobile station within a wireless network that does not require the use of specialized equipment such as PDEs. There is also a need in the art for an improved system and method that is capable of locating a mobile station within a wireless network in less time than that required by prior art systems.

### SUMMARY OF THE INVENTION

To address the deficiencies of the prior art, it is a primary object of the present invention to provide, for use in wireless network, a system and method for locating a mobile station.

The present invention comprises a distance unit associated with a base station that is capable of utilizing a random backoff parameter of the mobile station to determine the distance from the base station to the mobile station. The distance unit determines a one way travel time of a range signal from the base station to the mobile station and multiplies the one way travel time by the speed of light in order to obtain the distance from the base station to the mobile station. The one way travel time is obtained from one half the value of a quantity that is equal to a two way travel time of a range signal minus a time value of a random backoff parameter of the mobile station. The distance resolution of the system is approximately two hundred forty four meters.

It is an object of the present invention to provide an improved system and method for locating a mobile station within a wireless network.

It is also an object of the present invention to provide an improved system and method for locating a mobile station within a wireless network that does not require the use of specialized equipment referred to as “position determining entities”.

It is another object of the present invention to provide an improved system and method for locating a mobile station within a wireless network in less time than that required by prior art systems.

It is another object of the present invention to provide an improved system and method for locating a mobile station within an area between three base stations of the wireless network.

It is yet another object of the present invention to provide an improved system and method for locating a mobile station within a wireless network to within a distance resolution of approximately two hundred forty four meters.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith, ” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior uses, as well as to future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary prior art wireless network;

FIG. 2 illustrates an exemplary base station comprising a distance unit capable of determining a distance of a mobile station from a base station in a wireless network in accordance with the principles of the present invention;

FIG. 3 illustrates a triangular region in a prior art wireless network formed between three prior art base stations;

FIG. 4 illustrates a triangular region of a wireless network formed between a base station comprising a distance unit of the present invention, and two prior art base stations;

FIG. 5 illustrates a triangular region of a wireless network formed between three base stations in which each base station comprises a distance unit of the present invention; and

FIG. 6 illustrates a flow chart of an advantageous embodiment of a method of the present invention for determining the distance of a mobile station from a base station in a wireless network.

### DETAILED DESCRIPTION OF THE INVENTION

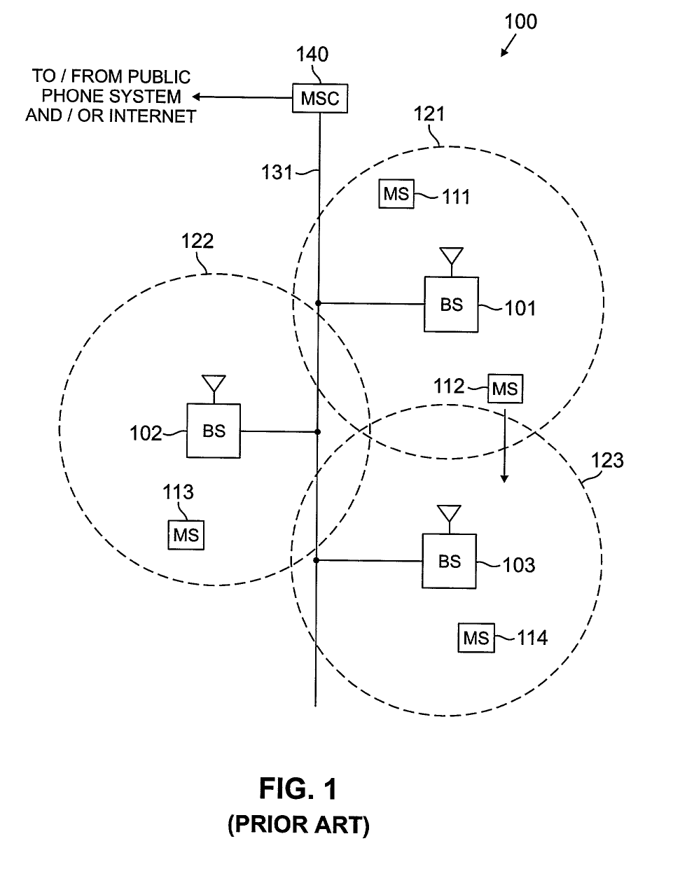

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates a general overview of an exemplary wireless network 100. The wireless telephone network 100 comprises a plurality of cell sites 121-123, each containing one of the base stations, BS 101, BS 102, or BS 103. Base stations 101-103 are operable to communicate with a plurality of mobile stations (MS) 111-114. Mobile stations 111-114 may be any suitable wireless communication devices, including conventional cellular telephones, PCS handsets, portable computers, telemetry devices, and the like, which are capable of communicating with the base stations via wireless links.

Dotted lines show the approximate boundaries of the cell sites 121-123 in which base stations 101-103 are located. The cell sites are shown approximately circular for the purposes of illustration and explanation only. It should be clearly understood that the cell sites also may have irregular shapes, depending on the cell configuration selected and natural and man-made obstructions.

Each of the base stations BS 101, BS 102, and BS 103 may comprise a base station controller (BSC) and a base transceiver station (BTS). Base station controllers and base transceiver stations are well known to those skilled in the art. A base station controller is a device that manages wireless communications resources, including the base transceiver station, for specified cells within a wireless communications network. A base transceiver station comprises the RF transceivers, antennas, and other electrical equipment located in each cell site. This equipment may include air conditioning units, heating units, electrical supplies, telephone line interfaces, and RF transmitters and RF receivers, as well as call processing circuitry. For the purpose of simplicity and clarity in explaining the operation of the present invention, the base transceiver station in each of cells 121, 122, and 123 and the base station controller associated with each base transceiver station are collectively represented by BS 101, BS 102 and BS 103, respectively.

BS 101, BS 102 and BS 103 transfer voice and data signals between each other and the public telephone system (not shown) via communications line 131 and mobile switching center (MSC) 140. Mobile switching center 140 is well known to those skilled in the art. Mobile switching center 140 is a switching device that provides services and coordination between the subscribers in a wireless network and external networks, such as the public telephone system and/or the Internet. Communications line 131 may be any suitable connection means, including a T1 line, a T3 line, a fiber optic link, a network backbone connection, and the like. In some embodiments, communications line 131 may be several different data links, where each data link couples one of BS 101, BS 102, or BS 103 to MSC 140.

In the exemplary wireless network 100, MS 111 is located in cell site 121 and is in communication with BS 101, MS 113 is located in cell site 122 and is in communication with BS 102, and MS 114 is located in cell site 123 and is in communication with BS 103. MS 112 is also located in cell site 121, close to the edge of cell site 123. The direction arrow proximate MS 112 indicates the movement of MS 112 towards cell site 123. At some point, as MS 112 moves into cell site 123 and out of cell site 121, a “handoff” will occur.

As is well known, a handoff transfers control of a call from a first cell to a second cell. For example, if MS 112 is in communication with BS 101 and senses that the signal from BS 101 is becoming unacceptably weak, MS 112 may then switch to a base station that has a stronger signal, such as the signal transmitted by BS 103. MS 112 and BS 103 establish a new communication link and a signal is sent to BS 101 and the public telephone network to transfer the on-going voice, data, or control signals through BS 103. The call is thereby seamlessly transferred from BS 101 to BS 103. An “idle” handoff is a handoff between cells of a mobile device that is communicating in the control or paging channel, rather than transmitting voice and/or data signals in the regular traffic channels.

One or more of the wireless devices in wireless network 100 may be capable of executing real time applications, such as streaming audio or streaming video applications. Wireless network 100 receives the real time data from, for example, the Internet and transmits it in the forward channel to the wireless device. For example, MS 112 may comprise a 3G cellular phone device that is capable of surfing the Internet and listening to streaming audio, such as music from the web site “www.mp3.com” or a sports radio broadcast from the web site “www.broadcast.com.” MS 112 may also view streaming video from a news web site, such as “www.CNN.com.” To avoid increasing the memory requirements and the size of wireless phone devices, one or more of the base stations in wireless network 100 provide real time data buffers that can be used to buffer real time data being sent to, for example, MS 112.

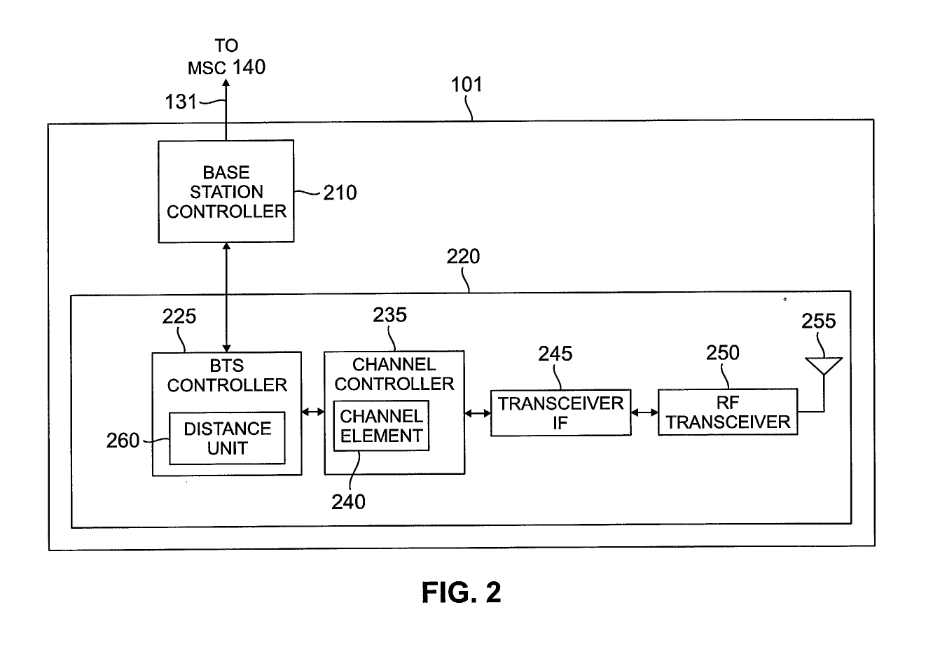

FIG. 2 illustrates in greater detail exemplary base station 101. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 220 comprises BTS controller 225, channel controller 235 with representative channel element 240, transceiver interface (IF) 245, RF transceiver unit 250, and antenna array 255.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A “forward” channel refers to outbound signals from the base station to the mobile station and a “reverse” channel refers to inbound signals from the mobile station to the base station. Transceiver IF 245 transfers the bi-directional channel signals between channel controller 235 and RF transceiver unit 250.

Antenna array 255 transmits forward channel signals received from RF transceiver unit 250 to mobile stations in the coverage area of BS 101. Antenna array 255 also sends to transceiver 250 reverse channel signals received from mobile stations in the coverage area of BS 101. In one embodiment, antenna array 255 may comprise a multi-sector antenna, such as a three sector antenna in which each antenna sector is responsible for transmitting and receiving in a one hundred twenty degree (1200) arc of coverage area. Additionally, RF transceiver 250 may contain an antenna selection unit to select among different antennas in antenna array 255 during both transmit and receive operations.

BTS controller 225 comprises distance unit 260 of the present invention. Distance unit 260 calculates a one way travel time D for a signal to travel to a mobile station (for example, mobile station 111 designated MS1) from base station 101 using the equation:

$$D = \frac{1}{2} [ ( two way travel time ) - ( randombackoff ) ] \qquad ( 1 )$$

where the two way travel time is a time measured in nanoseconds (ns) and where the random backoff is a chip length that is converted to time in nanoseconds (ns). The one way travel time D is expressed in nanoseconds (ns). A nanosecond is one billionth of a second (10⁻⁹ sec).

The random backoff parameter used in Equation (1) is specified in the IS-95 Code Division Multiple Access (CDMA) standard for CDMA networks (the “Standard”). The time duration of one binary digit (referred to as one “chip” or one “chip length”) equals the reciprocal of the bandwidth of the CDMA system. A value of 1.2288 MHz for the bandwidth of the CDMA system causes the chip length to be eight hundred thirteen and eight tenths nanoseconds (813.8 ns).

The random backoff parameter for mobile station MS1 represents a time duration after which mobile station MS1 starts a transmission. Depending upon the distance between mobile station 111 (MS1) and the base station BS 101, a mobile station may have a random backoff parameter with a chip length value of zero (0) up to a chip length value of five hundred eleven (511). As specified in the Standard, the random backoff parameter is calculated from the equation:

Random Backoff=2^{PNRAN}−1 (2)

where PNRAN is a pseudo noise random number having a value from zero (0) to nine (9). When PNRAN equals zero (0), the random backoff parameter equals zero (0). When PNRAN equals nine (9), the random backoff parameter equals five hundred eleven (511).

Whenever a mobile station originates a call on an access channel, the call attempt will be delayed for a time that is proportional to the distance of the mobile station from the base station. As described in the IS-95 CDMA Standard, the precise timing of an access channel transmission in an access attempt is determined by a procedure called PN (Pseudo Noise) randomization. For each access sub-attempt the PN randomization process computes RN (a PN randomization delay) as using a hash function. The hash function employs a hash key called RN_HASH_KEY that has a value between zero (0) and 2^{PROBE}^{_{—}}^{NRAN}−1. The value of the quantity PROBE_PN_RAN is dependent upon parameters such as PD (persistence delay), RA (random access channel number), RS (sequence backoff), and RT (probe backoff). One may consult the IS-95 CDMA Standard for additional details concerning PN (Pseudo Noise) randomization.

The PN randomization process uses the value of RN (a PN randomization delay) to determine the value of PNRAN that is used in Equation (2) to calculate the value of the random backoff parameter. The random backoff parameter of the mobile station represents the time offset after which the mobile station starts a transmission. The random backoff parameter of the mobile station is proportional to the distance of the mobile station from the base station. The mobile station continually informs the base station of the current value of the random backoff parameter for the mobile station.

In order to calculate the distance of mobile station 111 from base station 101 distance unit 260 uses a two way travel time of a range signal sent to and from the mobile station, and the random backoff parameter of the mobile station. A range signal is a signal sent from base station 101 to locate mobile station 111.

To calculate the two way travel time of the range signal to and from mobile station 111 distance unit 260 records the time of transmission of the range signal to mobile station 111. In response to receiving the range signal mobile station 111 sends a range signal transmission back to base station 101. Distance unit 260 records the time of arrival of the range signal transmission from mobile station 111. Distance unit 260 then subtracts the time of transmission from the time of arrival to obtain the two way travel time in nanoseconds.

Distance unit 260 then accesses the value of the random backoff parameter for mobile station 111 (designated MS1). Distance unit 260 then expresses the value of the random backoff parameter in nanoseconds using the fact that one chip length is equal to eight hundred thirteen and eight tenths nanoseconds (813.8 ns). Distance unit 260 then subtracts the value of the random backoff parameter in nanoseconds from the value of the two way travel time in nanoseconds. Distance unit 260 then divides the result by two (2) to obtain the one way travel time D in nanoseconds for a signal to travel from base station 101 to mobile station 111 (or vice versa).

The radio signal travels to and from mobile station 111 at the speed of light. The speed of light is 299,792,458 meters per second or 0.299,792,458 meters per nanosecond. Distance unit 260 multiplies the one way travel time D in nanoseconds for a signal to travel from base station 101 to mobile station 111 by the speed of light to obtain the distance from base station 101 to mobile station 111. One chip length of eight hundred thirteen and eight tenths nanoseconds (813.8 ns) corresponds to approximately two hundred forty four meters (244 m). The time resolution of distance unit 260 is one chip length. Therefore, distance unit 260 can locate the range of mobile station 111 from base station 101 to within two hundred forty four meters (244 m).

The time required for distance unit 260 to determine the distance from base station 101 to mobile station 111 is on the order of a few seconds. Distance unit 260 can determine the distance from base station 101 to mobile station 111 in less than ten (10) seconds. Prior art systems require longer times to accomplish the same result and may take as long ten (10) minutes. The present invention provides a significant improvement over the prior art in the time required to determine the distance of a mobile station from a base station. The present invention also provides a significant improvement over the prior art in that the present invention determines the distance of a mobile station from a base station using a random backoff parameter. No external specialized equipment is needed.

The present invention may be adapted to compensate for multipath signals. A multipath signal can arrive either earlier or later than a direct signal. Therefore a multipath signal can create either a positive or negative signal delay T with respect to the arrival of a direct signal. To use a multipath signal to determine the one way travel time D the signal delay T can be added to or subtracted from the two way travel time to compensate for the effect of the multipath time difference. After the multipath time difference has been corrected for, the one way distance is calculated in the manner previously described.

Similarly, the present invention may also be adapted to compensate for Doppler effects. As is well known, Doppler effect are frequency shifts that are caused by the motion of a transmitting mobile station toward or away from the base station.

To use a Doppler shifted signal to determine the one way travel time D, the amount of Doppler shift is first translated into a corresponding Doppler time period TD. The Doppler time period TD is then added to or subtracted from the two way travel time to compensate for the effect of the Doppler time difference. After the Doppler time difference has been corrected for, the one way distance is calculated in the manner previously described.

It is noted that similar corrections may be made to compensate for other types of signal conditions that cause a time difference in the arrival of a signal at a base station.

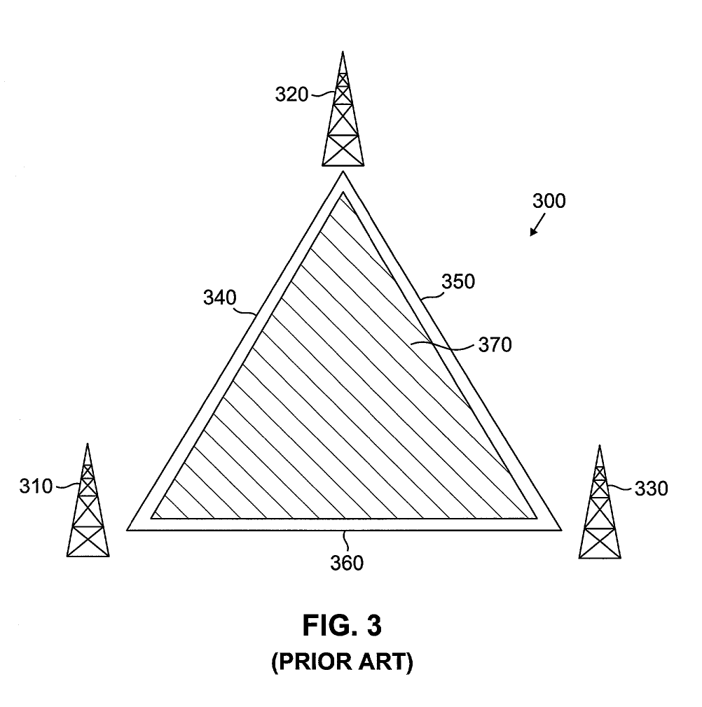

FIG. 3 illustrates a prior art triangular region 300 between a first base station 310, a second base station 320 and a third base station 330. Baseline 340 extends from first base station 310 to second base station 320. Baseline 350 extends from second base station 320 to third base station 330. Baseline 360 extends from third base station 330 to first base station 310.

A signal from a mobile station located within the triangle formed by the three baselines 340, 350 and 360 reaches the three base stations 310, 320 and 330. The shaded triangular portion 370 represents a region in which the location of the mobile station is unknown. The prior art system shown in FIG. 3 is not able to locate a mobile station. Therefore, the location of a mobile station within the shaded triangular portion 370 is completely unknown. The shaded triangular portion 370 is coextensive with the triangle formed by the three baselines 340, 350 and 360.

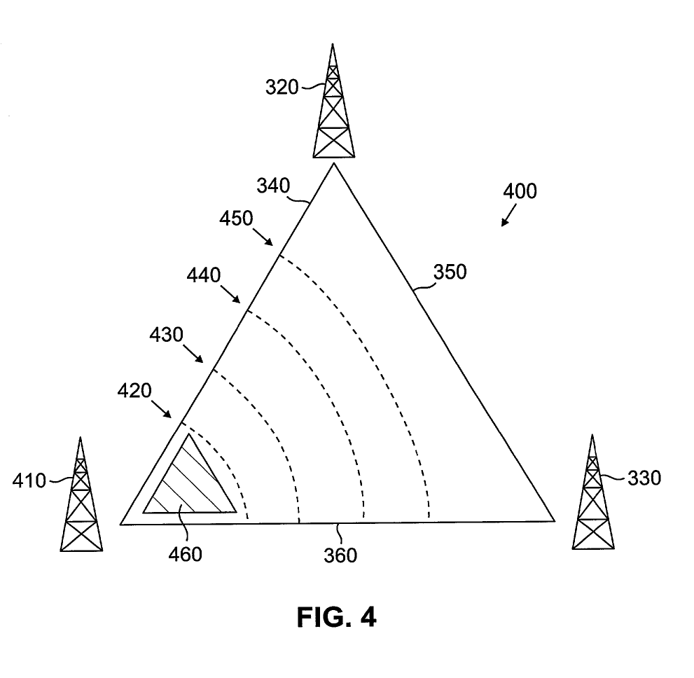

FIG. 4 illustrates a similar triangular region 400 between a first base station 410 comprising distance unit 260 of the present invention, a prior art second base station 320 and a prior art third base station 330. Triangular region 400 also comprises the three baselines, 340, 350 and 360, shown in FIG. 3, except that base station 310 of FIG. 3 has been replaced by base station 410 in FIG. 4. First base station 410 in FIG. 4 is capable of determining the distance of a mobile station from base station 410 in accordance with the principles of the present invention.

Arc 420 represents a distance from base station 410 that corresponds to two hundred forty four meters (244 m), the minimum resolution distance for distance unit 260. The distance of two hundred forty four meters (244 m) will be referred to as a “basic unit” of distance. If a mobile station is closer to base station 410 than two hundred forty four meters (244 m), then distance unit 260 will not be able to determine the distance to the mobile station. The shaded triangular portion 460 represents a region in which the location of the mobile station is unknown to base station 410.

Arc 430, arc 440 and arc 450 represent distances from base station 410 that respectively correspond to two, three and four basic units of distance. Additional arcs (not shown) may represent additional distances from base station 310 that are integral multiples of the basic unit of distance.

The distance information represented by arc 420, arc 430, arc 440 and arc 450 may be used to identify distance zones within triangular region 400. The fact that a mobile station may be located to within approximately two hundred forty meters from a base station allows the creation of distance zones based on the distance from the base station. Zone based services may be based upon the location of mobile station within a particular distance zone. For example, Quality of Service (QoS) may be provided to mobile station users based upon the zone in which the mobile station is located. Users who are located in a distance zone close to the base station may be guaranteed higher levels of QoS than users who are farther away from the base station.

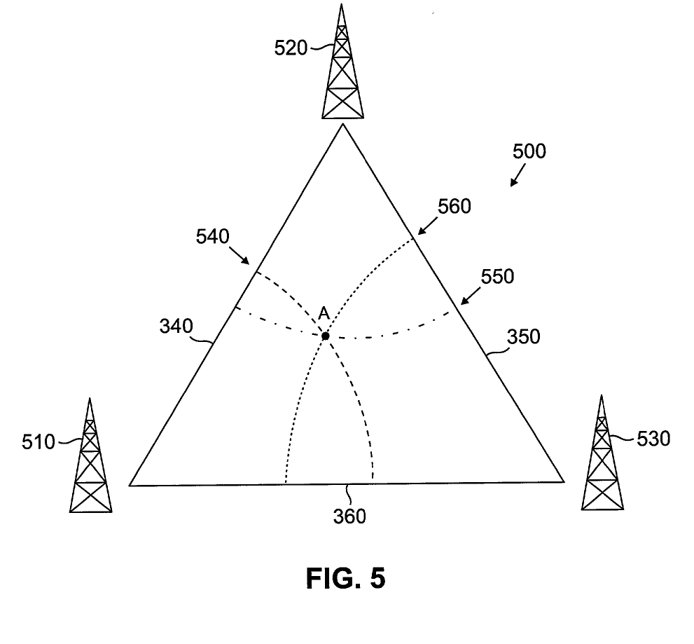

FIG. 5 illustrates a triangular region 500 between a first base station 510, a second base station 520 and a third base station 530. Triangular region 500 also comprises the three baselines 340, 350 and 360 shown in FIG. 3, except that base stations 310, 320 and 330 in FIG. 3 have been replaced by base stations 510, 520 and 530 in FIG. 5. First base station 510, second base station 520 and third base station 530 in FIG. 5 are each provided with a distance unit 260 of the present invention. Each of the three base stations 510, 520 and 530 are capable of determining the distance to a mobile station within triangular region 500.

In this advantageous embodiment of the present invention, a specific location of a mobile station (indicated by the letter A in FIG. 5) may be determined to within the resolution of the basic unit of distance of two hundred forty four meters (244 m). As shown in FIG. 5, arc 540 locates the distance of the mobile station from base station 510. Arc 550 locates the distance of the mobile station from base station 520. Arc 560 locates the distance of the mobile station from base station 330. The three arcs cross at the location of the mobile station. The location of the mobile station is designated point A.

The location of point A may be calculated in distance unit 260 of base station 510, or in distance unit of base station 520, or in distance unit 260 of base station 530. The base station that calculates the location of point A (e.g., base station 510) receives from the other base stations (e.g., base station 520 and base station 530) information concerning the distance of the mobile station from the other two base stations.

Alternatively, the location of point A may be calculated in a separate calculator unit (not shown) at a remote location not within base station 510, base station 520, or base station 530. The separate calculator unit must receive information from each of the three base stations 510, 520 and 530, concerning the distance of the mobile station from the base station.

Three arcs are used to locate the mobile station because using only two arcs would lead to an ambiguous result due to the fact that any two of the arcs also cross at a second point outside of the triangular region 500. The use of three arcs removes all ambiguity in the location of the mobile station.

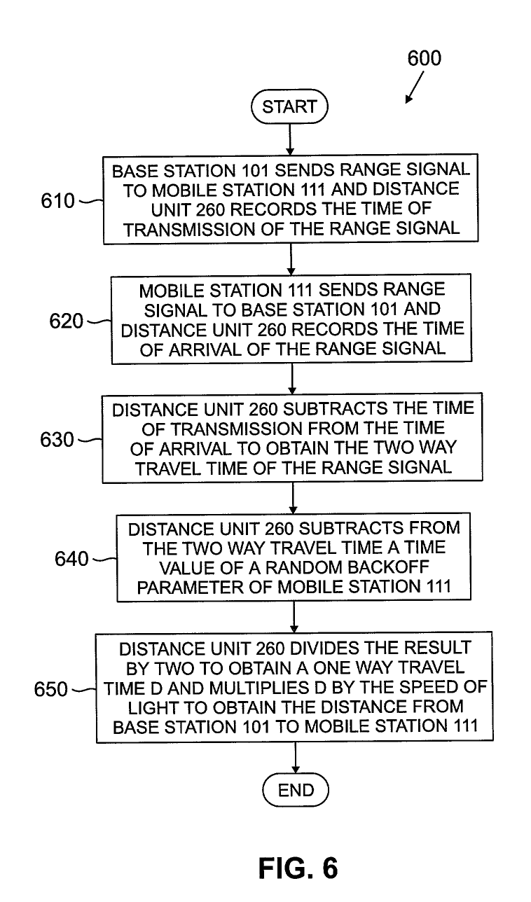

FIG. 6 illustrates a flowchart of an advantageous embodiment of a method of the present invention for determining the distance of a mobile station from a base station. The steps of the method are generally denoted with reference numeral 600. Base station 101 sends a range signal to mobile station 111 and distance unit 260 records the time of transmission of the range signal (step 610).

Mobile station 111 then sends a range signal to base station 101 and distance unit 260 records the time of arrival of the range signal at base station 101 (step 620). Distance unit 260 then subtracts the time of transmission of the range signal to mobile station 111 from the time of arrival of the range signal from mobile station 111 to obtain the two way travel time of the range signal (step 630). The two way travel time is expressed in nanoseconds.

Distance unit 260 subtracts from the two way travel time a time value of the random backoff parameter of mobile station 111 (step 640). As previously explained, the time value of the random backoff parameter is expressed in nanoseconds where one chip length is equal to eight hundred thirteen and eight tenths nanoseconds (813.8 ns).

Distance unit 260 divides the result by two (2) to obtain a one way travel time D and then multiplies the one way travel time D by the speed of light to obtain the distance from base station 101 to mobile station 111 (step 650).

It is important to note that while the present invention has been described in the context of a fully functional network device, those skilled in the art will appreciate that the mechanism of the present invention is capable of being implemented and distributed in the form of a computer usable medium of instructions in a variety of forms, and that the present invention applies equally regardless of the particular type of signal bearing medium used. Examples include, but are not limited to: nonvolatile, hard-coded or programmable type mediums such as read only memories (ROMs) or erasable, electrically programmable read only memories (EEPROMs), recordable type mediums such as floppy disks, hard disk drives, and read/write (R/W) compact disc read only memories (CD-ROMs) or digital versatile discs (DVDs), and transmission type mediums such as digital and analog communications links.

Although the present invention has been described in detail, those skilled in the art will understand that various changes, substitutions, and alterations herein may be made without departing from the spirit and scope of the invention it its broadest form.

What is claimed is:

1. For use in wireless network communications system comprising a plurality of base stations and a plurality of mobile stations, an apparatus for determining a distance from a base station to a mobile station, said apparatus comprising:
a distance unit associated with said base station wherein said distance unit is capable of determining a one way travel time D of a signal from said base station to said mobile station; and
wherein said distance unit is capable of multiplying said one way travel time D by the speed of light to obtain said distance from said base station to said mobile station.

2. The apparatus as set forth in claim 1 wherein said distance unit is capable of determining said one way travel time D from:
$$D = \frac{1}{2} [ ( two way travel time ) - ( random backoff ) ]$$
wherein said two way travel time is a time of travel for a range signal to travel from said base station to said mobile station and to travel from said mobile station to said base station; and
wherein said random backoff is a time value of a chip length of a random backoff parameter of said mobile station.

3. The apparatus as set forth in claim 2 wherein said distance unit is capable of obtaining said two way travel time by subtracting an arrival time of said range signal at said base station from said mobile station from a transmission time of said range signal from said base station to said mobile station.

4. The apparatus as set forth in claim 2 wherein said random backoff parameter for said mobile station has a chip length value between zero chip lengths and five hundred eleven chip lengths.

5. The apparatus as set forth in claim 4 wherein a time value for one chip length value is eight hundred thirteen and eight tenths nanoseconds.

6. The apparatus as set forth in claim 1 wherein said distance unit is capable of obtaining a distance from said base station to said mobile station with a distance resolution of approximately two hundred forty four meters.

7. The apparatus as set forth in claim 2 wherein said distance unit is capable of adjusting a value of said two way travel time to correct a time difference of a signal comprising one of: a multipath signal and a Doppler shifted signal.

8. A wireless network communications system comprising a base station and a mobile station, said base station comprising an apparatus for determining a distance from said base station to said mobile station, said apparatus comprising:
a distance unit associated with said base station wherein said distance unit is capable of determining a one way travel time D of a signal from said base station to said mobile station; and
wherein said distance unit is capable of multiplying said one way travel time D by the speed of light to obtain said distance from said base station to said mobile station.

9. The wireless network communications system as set forth in claim 8 wherein said distance unit is capable of determining said one way travel time D from:
$$D = \frac{1}{2} [ ( two way travel time ) - ( random backoff ) ]$$
wherein said two way travel time is a time of travel for a range signal to travel from said base station to said mobile station and to travel from said mobile station to said base station; and
wherein said random backoff is a time value of a chip length of a random backoff parameter of said mobile station.

10. The wireless network communications system as set forth in claim 9 wherein said distance unit is capable of obtaining said two way travel time by subtracting an arrival time of said range signal at said base station from said mobile station from a transmission time of said range signal from said base station to said mobile station.

11. The wireless network communications system as set forth in claim 9 wherein said random backoff parameter for said mobile station has a chip length value between zero chip lengths and five hundred eleven chip lengths.

12. The wireless network communications system as set forth in claim 11 wherein a time value for one chip length value is eight hundred thirteen and eight tenths nanoseconds.

13. The wireless network communications system as set forth in claim 8 wherein said distance unit is capable of obtaining a distance from said base station to said mobile station with a distance resolution of approximately two hundred forty four meters.

14. The wireless network communications system as set forth in claim 9 wherein said distance unit is capable of adjusting a value of said two way travel time to correct a time difference of a signal comprising one of: a multipath signal and a Doppler shifted signal.

15. For use in wireless network communications system comprising a base station and a mobile station, a method of determining a distance from said base station to said mobile station comprising the steps of:
determining with a distance unit associated with said base station a one way travel time D of a signal from said base station to said mobile station; and
multiplying said one way travel time D by the speed of light to obtain said distance from said base station to said mobile station.

16. The method as set forth in claim 15 wherein the step of determining with a distance unit associated with said base station a one way travel time D of a signal from said base station to said mobile station comprises the step of:
calculating said one way travel time D from:
$$D = \frac{1}{2} [ ( two way travel time ) - ( random backoff ) ]$$
wherein said two way travel time is a time of travel for a range signal to travel from said base station to said mobile station and to travel from said mobile station to said base station; and
wherein said random backoff is a time value of a chip length of a random backoff parameter of said mobile station.

17. The method as set forth in claim 16 further comprising the step of:
obtaining said two way travel time by subtracting an arrival time of said range signal at said base station from said mobile station from a transmission time of said range signal from said base station to said mobile station.

18. The method as set forth in claim 16 wherein said random backoff parameter for said mobile station has a chip length value between zero chip lengths and five hundred eleven chip lengths.

19. The method as set forth in claim 18 wherein a time value for one chip length value is eight hundred thirteen and eight tenths nanoseconds.

20. The method as set forth in claim 15 further comprising the step of:
obtaining with said distance unit a distance from said base station to said mobile station with a distance resolution of approximately two hundred forty four meters.

21. The method as set forth in claim 16 further comprising the step of:
adjusting in said distance unit a value of said two way travel time to correct a time difference of a signal comprising one of: a multipath signal and a Doppler shifted signal.

22. The method as set forth in claim 15 wherein said distance unit determines a distance from said base station to said mobile station in less than ten seconds.

23. For use in wireless network communications system comprising a plurality of base stations and a plurality of mobile stations, a method for locating a mobile station in an area between three base stations, said method comprising the steps of:
determining with a distance unit associated with each of said three base stations a one way travel time D of a signal from each respective station to said mobile station where
$$D = \frac{1}{2} [ ( two way travel time ) - ( random backoff ) ]$$
wherein said two way travel time is a time of travel for a range signal to travel from each respective base station to said mobile station and to travel from said mobile station to each respective base station;
wherein said random backoff is a time value of a chip length of a random backoff parameter of said mobile station;
multiplying each respective one way travel time D by the speed of light to obtain each respective distance from each respective base station to said mobile station; and
identifying a location of said mobile station within said area between said three base stations using said respective distances of said mobile station from said respective base stations.

24. The method as set forth in claim 23 wherein said location of said mobile station within said area between said three base stations has a distance resolution of approximately two hundred forty four meters.

25. The method as set forth in claim 23 wherein the step of identifying said location of said mobile station within said area between said three base stations using said respective distances of said mobile station from said respective base stations comprises the steps of:
providing said respective distances of said mobile station from said respective base stations to a distance unit within one of said three base stations; and
calculating in said distance unit a location of said mobile station from said respective distances of said mobile station from said respective base stations.

26. The method as set forth in claim 23 wherein the step of identifying said location of said mobile station within said area between said three base stations using said respective distances of said mobile station from said respective base stations comprises the steps of:
providing said respective distances of said mobile station from said respective base stations to a calculator unit not located within said three base stations; and
calculating in said calculator unit a location of said mobile station from said respective distances of said mobile station from said respective base stations.

27. For use in wireless network communications system comprising a plurality of base stations and a plurality of mobile stations, an apparatus for locating a mobile station in an area between three base stations, said apparatus comprising:
a distance unit associated with each of said three base stations wherein said distance unit is capable of determining a one way travel time D of a signal from each respective station to said mobile station where
$$D = \frac{1}{2} [ ( two way travel time ) - ( random backoff ) ]$$
wherein said two way travel time is a time of travel for a range signal to travel from each respective base station to said mobile station and to travel from said mobile station to each respective base station;
wherein said random backoff is a time value of a chip length of a random backoff parameter of said mobile station;
wherein said distance unit is capable of multiplying each respective one way travel time D by the speed of light to obtain each respective distance from each respective base station to said mobile station; and
wherein said distance unit is capable of identifying a location of said mobile station within said area between said three base stations using said respective distances of said mobile station from said respective base stations.

28. The apparatus as set forth in claim 27 wherein said location of said mobile station within said area between said three base stations has a distance resolution of approximately two hundred forty four meters.

29. The apparatus as set forth in claim 27 wherein said distance unit is capable of calculating a location of said mobile station from said respective distances of said mobile station from said respective base stations.

30. The apparatus as set forth in claim 27 further comprising:
a calculator unit coupled to said three base stations but not located within said three base stations, said calculator unit capable of receiving from said three base stations said respective distances of said mobile station from said respective base stations;
wherein said calculator unit is capable of calculating a location of said mobile station from said respective distances of said mobile station from said respective base stations.
